(19) United States
(12) Patent Application Publication
(10) Pub. No.: US 2018/0005181 A1
(43) Pub. Date: Jan. 4, 2018

(54) METHOD OF LOADING/UNLOADING CONTAINERS IN A PORT FACILITY

(71) Applicant: BATTERIE MOBILE, Hericourt (FR)

(72) Inventor: Christophe GAUSSIN, Grandvaux (CH)

(21) Appl. No.: 15/543,119

(22) PCT Filed: Jan. 15, 2016
(86) PCT No.: PCT/FR2016/050078

§ 371 Date: Jul. 12, 2017

(30) Foreign Application Priority Data
Jan. 15, 2015 (FR) 1550316
Feb. 27, 2015 (FR) 1551707

(51) Int. Cl. G06Q 10/08; B65G 63/04; B65G 67/60; B65G 67/02; B63B 27/12; B66C 19/00; B65G 63/00

(52) U.S. Cl. CPC G06Q 10/0832; B65G 67/02; B65G 63/045; B63B 27/12; B65G 67/60; B65G 63/004; B66C 19/007; G05D 2201/0205

(57) ABSTRACT

There is the method of loading and unloading containers in a port facility. The facility includes quayside cranes, automated gantries for stacking/unstacking containers, vehicles for transporting containers, communication lanes for vehicles including transit lanes under each quayside crane and parallel circulation lanes situated between the quayside cranes and access lanes to the automated gantries. The method includes managing journeys of the vehicles as a function of the container removal and placement requirements, in particular the allocating to each vehicle of a task and of a destination and the selecting of a provisional parking site for the vehicles in transit in buffer zones provided for this purpose. The vehicles are assigned to provisional parking sites under the cranes and/or in the proximal circulation lane of the cranes, which are used as a buffer zone.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a method for optimizing the loading/unloading of containers in a harbor facility. These facilities typically include ship-to-shore cranes for loading/unloading the ships at berth, automated gantries for stacking/unstacking containers that are located in areas designated for temporarily storing the containers in the harbor area, the cranes and said gantries being indeed in most cases technically very similar, they may for example take the form of lifting platforms or equivalent. Container transport vehicles are then loaded to carry out the link between the cranes and the gantries.

The invention also relates to a particular arrangement of the functional elements, such as those mentioned above, in a harbor facility, in order to optimize the operations of loading and unloading the ships.

### 2. Description of Related Art Including Information Disclosed Under 37 CFR 1.97 and 37 CFR 1.98

In order to connect the different areas of operation, i.e. in practice said functional elements, communication lanes are provided for the vehicles, which include passageways under the ship-to-shore cranes and parallel traffic lanes located between the ship-to-shore cranes and access lanes to the automated gantries. Parking locations are furthermore used for parking container transport vehicles, which are temporarily not assigned to a transshipment task or which cannot have access under their ship-to-shore crane or under their automated destination gantry. In the following description will be designated by vehicles in transit all those vehicles, which, for various reasons, must be brought to these parking locations. The objective of optimization of the paths of the vehicles, which in fact represents the dynamic management of a fleet comprised of many vehicles to be organized according to the needs of removal and deposition of containers, is crucial to the proper operation of a harbor, namely because of the increasing importance of the sea-going container traffic and the current trend towards gigantism of the harbors resulting therefrom. This management namely includes the allocation to the active vehicles of a task and a destination and, in the event of a complete automation of the vehicles, information on the path to be followed. Since the flow of containers varies depending on the number of ships at berth and the period of the day, optimizing the transshipments of the containers necessarily includes the management of the vehicles that are temporarily unused, even that can temporarily not have access to their destination, and therefore, among the information to be processed, the selection of a temporary parking location for these so-called vehicles in transit. So-called buffer zones are provided for this purpose in the harbors, preferably located in the center of the active areas, so that, when a vehicle passes from the “inactive” status to the “activated” status, it can become operational as quickly as possible.

In the current arrangements, i.e. with the setting up of the functional elements as they exist in the harbor terminals, these temporary parking locations are arranged in the immediate vicinity of the cranes, occupying a space between the passageways under the cranes and the parallel traffic lanes. The latter namely permit to go to the access roads to the automated gantries, which end with individual container deposition/removal stations. Several stations of this kind cooperate with each automated container stacking/unstacking gantry, and permit a reversible operation of the type: a/ the vehicles bring a container to a station, which is unloaded by means of the gantry, which then stacks it with other containers for temporary storage before sending it to a final destination outside the harbor, b/ the gantry unstacks a container from a temporary storage pile and places it on such a station for its removal by a vehicle that brings it to a ship-to-shore crane, which transships it onto a ship. The same reversible operation applies also to ship-to-shore cranes.

These temporary parking areas, the functional necessity of which is indisputable in view of the conditions of optimization of the transshipments of containers and the current installations are, however, at the same time an obstacle to the territorial and economic development of the container handling terminals and also a methodological obstacle to the optimization of the management, namely in a complete automation perspective.

It is known that the issue of available space is crucial in many parts of the world, both in the economic aspect, since the land is expensive, and in a purely practical perspective in some parts of the world where there is a lack of same, the scarcity of space increasing the financial burden significantly. The examples of the island harbors of Singapore and Hong Kong, which are however leading container processing terminals, are instructive in this respect: they are considered as major places in the world sea-going container traffic, the expansion of which would be fully justified by the current increase in traffic, but for which the more than economic geographical constraints are real obstacles to any development.

At a purely methodological level, and always with a view to optimizing the flows of containers within the harbor, these “inactive” parking areas that are placed between two areas of high activity—the cranes and the stacking/unstacking gantries—have a double impact on the transshipment time (they increase the paths and require a sequential processing of the operations), on the one hand, and the paths to be foreseen, on the other hand, which is thus also prejudicial to the processing cost and, ultimately, the economic attractiveness of the terminal.

In order to emerge from under the cranes when they are loaded with a container, or to access a location under a crane for unloading a container, the vehicles must use the passageways and pass under all the cranes during a complete operation: therefore, in practice they circulate from one end to the other of at least one lane under the cranes. This implies furthermore that only one location is occupied by the crane and that all others are free, thus preserving the passageway. This results into these locations then being unavailable for a loading/unloading operation. In conclusion, this operation requires the loading/unloading operations to be sequenced, and to find a temporary location for a large number of so-called vehicles in transit, even in case of high activity of the harbor terminal.

### BRIEF SUMMARY OF THE INVENTION

The invention copes with these shortcomings and deficiencies by providing a solution permitting to eliminate this “dead” parking area for temporarily unused container transport vehicles in transit. The “useful” space saving is thereby significantly increased, and the significantly shorter paths of the vehicles permit a significant time saving. The invention furthermore permits an operation that is no longer sequenced, but in parallel. These features are analyzed as a considerable overall economic gain for the harbor facility equipped with the invention.

Principally, the method for loading/unloading containers according to the invention, for which it is reminded that it includes the optimized management of the paths of the vehicles based on the container transshipment needs, and as such namely the allocation to each vehicle of a task and a destination and the selection of a temporary parking location for the vehicles in transit, in buffer areas provided for this purpose, is characterized in that said vehicles in transit are assigned to temporary parking locations under the cranes and/or on the transfer lanes proximate the cranes, used as a buffer.

The complete disappearance of the buffer area previously located between the passageways under the cranes and traffic lanes leads to a gain of ground surface close to 20%, which is considerable, namely in places where space is precious and expensive.

Furthermore, yet according to the invention, for parking in the part of the buffer area under a crane, the path assigned to a vehicle, depending on the exact location under the crane, which is assigned to it, is calculated so as to cover a minimum distance compatible with the capacities and characteristics of the vehicle, in particular its steering radius and its length, and without passing under an adjacent crane.

The vehicle arriving from an automated gantry and passing through the traffic lanes parallel to the passageways under the cranes can turn between two cranes and occupy a location under a crane, for a transshipment operation or for temporary parking. Likewise, as soon as the loading/unloading is completed by a crane, or upon receipt of instructions related to a task to be carried out, the vehicle can leave its location under the crane and turn to directly join a traffic lane. It is no longer necessary to use the passageways under the crane for the purpose of circulating along the quay. All locations under the cranes can moreover potentially be used simultaneously, which leads to a considerable increase of operations that can be carried out at the same time and within a given period.

According to a possibility specific to the invention, the path assigned to an empty vehicle is calculated taking into consideration the possibility of entering into/leaving a location under a crane on either side of said crane. This feature provides the method with unmatched flexibility, since the number of possibilities of paths in connection with the calculated paths of the other vehicles within the same period has increased significantly.

As an alternative, the path assigned to a vehicle loaded with a container can be calculated, according to the method of the invention, taking into consideration the possibility of entering into a location under a crane on one side and leaving on either side, for structural reasons related to the configuration of the cranes.

The invention also relates to an arrangement of the functional elements in a harbor facility including a plurality of ship-to-shore cranes placed perpendicular to the direction of the quay, automated container stacking/unstacking gantries, communication lanes for container transport vehicles including passageways under each ship-to-shore crane, parallel traffic lanes located between the ship-to-shore cranes and the access roads to the automated gantries, as well as buffer areas for parking container transport vehicles in transit. The arrangement of these functional elements is different, according to the invention, in that the cranes are spaced apart from each other so that the container transport vehicles can position themselves under a crane leave without passing under the adjacent cranes, and in that said buffer areas are formed of locations arranged under the cranes and/or on the traffic lane proximate to the cranes.

The condition of this new arrangement thus resides in a proper spacing of the cranes, which in practice is, however, only little or not larger than what existed before, the current container transport vehicles being such that they can be steered and turn at right angle in a very limited space. The use of the proximate traffic lane increases, if necessary, the possibilities of temporary storage, knowing that even in this case, the clearance and access paths to the cranes are not blocked: only locations which do not negatively affect the movements of container transport vehicles are used.

### BRIEF DESCRIPTION OF THE SEVERAL VIEWS OF THE DRAWINGS

The invention will now be described in more detail by means of the following figures.

FIG. 1 is a schematic view of a harbor facility according to the invention.

FIG. 2 shows a schematic view of a facility, shown in the same way, which represents the prior art.

FIG. 3 shows a schematic view of two distinct diagrams the phases of entering and leaving, respectively, of a container transport vehicle traveling empty, according to the method of the invention.

FIG. 4 shows a schematic view of an exemplary operation particularly optimized thanks to the contribution of the invention.

FIG. 5 is a schematic view of the counterpart of FIG. 3, for a vehicle loaded with a container.

### DETAILED DESCRIPTION OF THE INVENTION

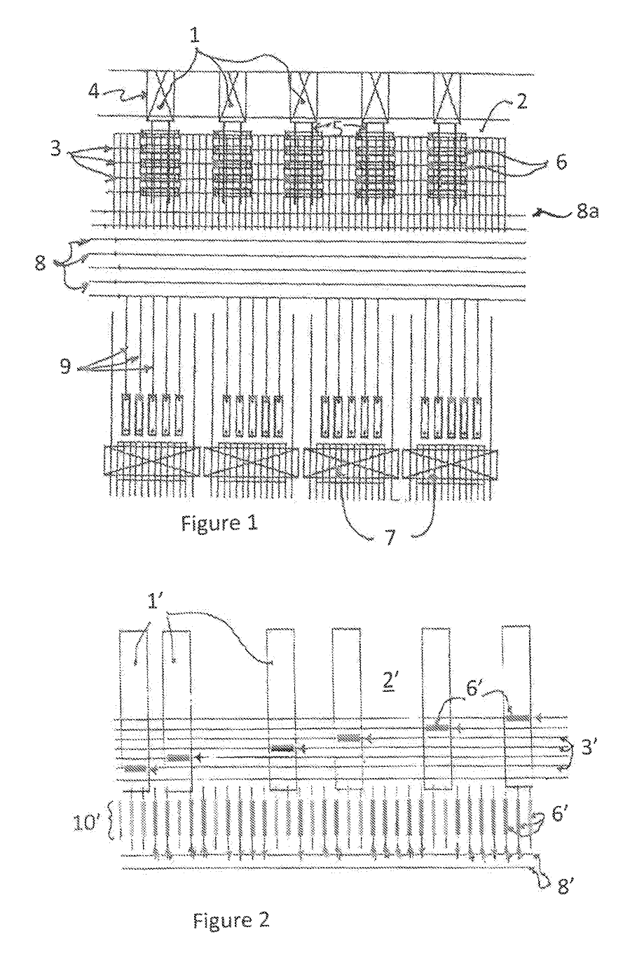

When referring to FIG. 1, the harbor facility includes cranes (1) located essentially perpendicular to the quay (2) and covering passageways (3). The harbor cranes (1) are conventionally in the form of lifting platforms, and include a portion (4) located above the basin, and hence of a ship when one is at dock, and a portion (5) located above the passageways (3), which is potentially located above the container transport vehicles (6) or temporarily parked at this location, according to an original feature of the invention, or during loading/unloading.

Automated gantries (7), which also permit the loading/unloading of vehicles (6), organize the storage by stacking of containers proceeding from ships and hence from the cranes (1). Conversely, they are also used for unstacking containers they take from the inventories formed for loading empty transport vehicles (6), which then transship them to the cranes (1).

Between the crane area (1), on the one hand, and the storage area comprising the gantries (7), on the other hand, traffic lanes (8) parallel to the passageways (3) and more generally to the quay (2) are provided in order to permit the vehicles (6) to move between the aforementioned two areas. The proximal lane (8a) can be assigned to a temporary parking. These lanes (8) are for a single direction of circulation, in particular in order to facilitate the automation of the loading/unloading method, as shown by the arrows on the lines, which symbolize them.

Access lanes (9) to the automated gantries (7) end on the said traffic lanes (8). At their end, container deposition/removal stations, the number of which is equal to that of the access lanes (9), are provided for cooperating with a gantry (7).

The facility of the prior art, shown in FIG. 2, includes in practice the same functional elements, and is only partially shown in order to highlight the differences with the invention. Thus, in FIG. 2, the crane area (1′) at the level of the quay (2′) is represented as a principal, as well as only two traffic lanes (8′), the main structural difference being at this level. It essentially consists in the existence, in the prior art, of a buffer area (10′) for parking the so-called container transport vehicles (6′) in transit when they are not assigned to a specific task or when they cannot access their destination. In other words, all the vehicles that are not in use temporarily or cannot access a ship-to-shore crane, for example, must be parked to avoid congesting the traffic lanes of these vehicles, unless they impede the progress of other vehicles having an assigned task and are likely to perform it. This buffer zone (10′) separates in practice the passageways (3′) from the traffic lanes (8′), requiring the vehicles (6′) in transit to go to the end of the ones in order to have access to the others. This obligation of circulating on the full length of the lanes (3′) has several consequences, which is prejudicial to the possibilities of optimization, because, besides a significant increase in processing time, it permits only one vehicle per lane (3′) to be loaded/unloaded by a crane (1), and the other lanes (3′) must be left free for the circulation of the other vehicles (6′). Finally, the system should provide for shifting the processing locations from one crane (1′) to another, which requires for the automated system a constant scanning of the activity of each crane (1′) in order to obtain this information, and a sequencing of the operations. This causes multiple and repeated losses of time and significantly increases the overall processing of the information in a method for automating the operation of a harbor facility. Mainly the sequencing due to the necessity of processing only one vehicle (6′) per crane (1′) results into the need for a temporary parking area.

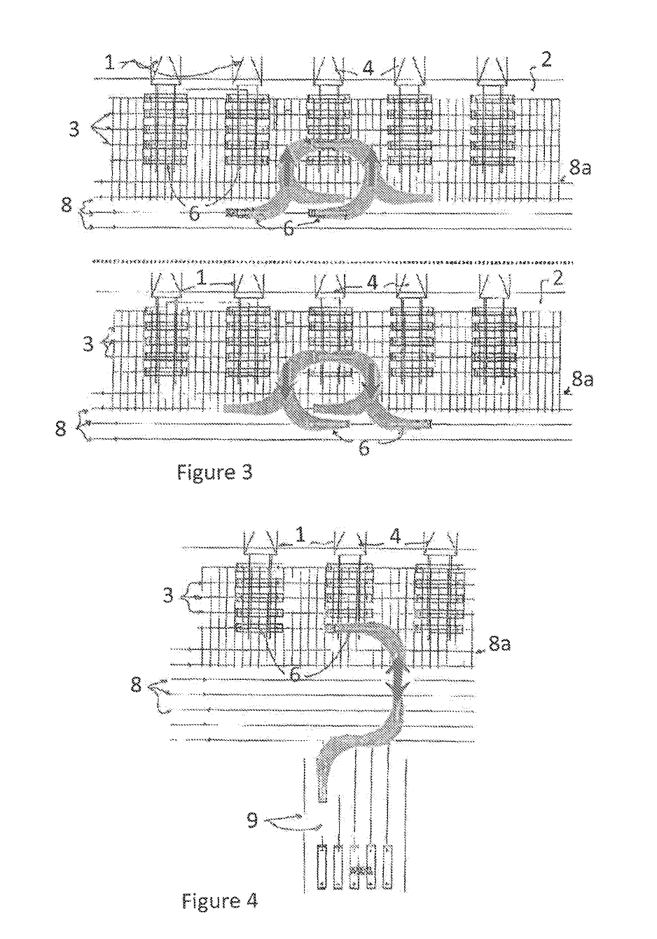

On the other hand, in the operation of the invention, such as for example shown in FIG. 3 for empty vehicles (6) in transit, i.e. to which the processing system has assigned the task of going empty to a predetermined location for a container, the number of transfer locations is multiplied by 5 per crane (1), and it is no longer necessary to proceed to a sequencing. The possible paths of the vehicles (6) are represented by the grey shaded loop, the arrows symbolizing the paths for entering and leaving, respectively, from and to the traffic lanes (8), while respecting their direction of circulation. The operations for reaching/leaving a location under a crane (1) are the same for the 5 locations under each crane (1), as depicted in the drawing.

FIG. 4 shows a particular case in that the path between the automated gantry (7) and the crane (1), which path is assigned by the facility management program, is the shortest possible one in an arrangement such as shown in FIG. 1. Whenever possible, this path is programmed by the automated operating system, for optimization purposes, i.e. in practice in order to obtain a time gain, to which is added an energy saving, etc.

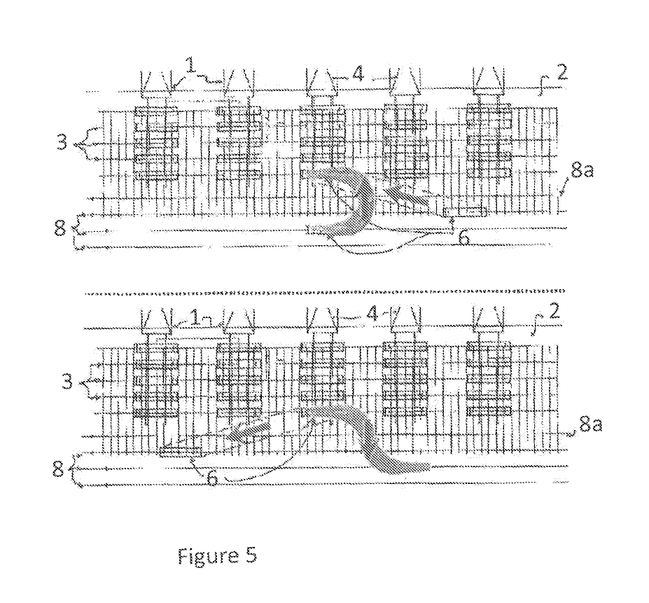

FIG. 5 shows the procedure that a vehicle (6) loaded with a container follows to reach an assigned location: in this case, due to the presence of the container on the trailer, it must comply with a direction of entering, namely due the configuration of the extraction system of the crane (1), and which may require a half turn if the traffic lane (8) of arrival requires so. In order to leave, as shown in the lower part of FIG. 5, and according to the direction of circulation of the lane (8) assigned by the system, the displacement may occur in two different directions.

The examples of configuration described with reference to Figures are not exhaustive of the invention, which also encompasses the variants which fall within the scope of the claims.

1. A method for loading and unloading containers in a harbor facility, said harbor facility being comprised of ship-to-shore cranes, automated container stacking/unstacking gantries, vehicles for transporting containers between the cranes and the gantries as well as communication lanes for said vehicles including passageways under each ship-to-shore crane and parallel traffic lanes located between the ship-to-shore cranes and access roads to the automated gantries, the method comprising the steps of:
managing paths of the vehicles depending on the needs of removal or deposition of the containers, and
assigning to each vehicle of a task and a destination and the selection of a temporary parking location for the vehicles in transit in buffer areas provided for this purpose,
wherein container transport vehicles in transit are assigned to temporary parking locations under the cranes and/or on the traffic lanes proximate to the cranes, used as a buffer area.

2. The method for loading and unloading containers in a harbor facility, according to the preceding claim, wherein, for parking in a location of the buffer area located under a crane, the path assigned to a vehicle, depending on the exact location under the crane assigned to same, is calculated so as to cover a minimal distance compatible with the capacities and characteristics of the vehicle, in particular its steering radius and its length and without passing under an adjacent crane.

3. The method for loading and unloading containers in a harbor facility, wherein the path assigned to an empty vehicle is calculated taking into consideration the possibility of entering into/leaving a location under a crane on both sides of said crane.

4. The method for loading and unloading containers in a harbor facility, according to claim 2, wherein the path assigned to a vehicle loaded with a container is calculated taking into consideration the possibility of entering into a location under a crane on one side and of leaving on either side.

5. An arrangement of the functional elements of a harbor facility comprising: a plurality of ship-to-shore cranes placed perpendicular to the direction of the quay, automated container stacking/unstacking gantries, communication lanes for container transport vehicles including passageways under each ship-to-shore crane, parallel traffic lanes located between the cranes and access roads to the automated gantries, as well as buffer areas for parking the container transport vehicles in transit, wherein the cranes are spaced apart so that the container transport vehicles placed under a crane and leave it without passing under the adjacent crane, and wherein said buffer areas are formed by locations arranged under the cranes and/or on the traffic lane proximate to the cranes.
